(19) United States
(12) Patent Application Publication
(10) Pub. No.: US 2026/0288286 A1
(43) Pub. Date: Sep. 24, 2026

(54) TOUCH DISPLAY PANEL AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Jun YAN, Beijing (CN); Xiangdan DONG, Beijing (CN); Ting LI, Beijing (CN); Kemeng TONG, Beijing (CN)

(21) Appl. No.: 19/479,730

(22) PCT Filed: Jan. 15, 2025
(86) PCT No.: PCT/CN2025/072573

§ 371 Date: Oct. 28, 2025

(30) Foreign Application Priority Data
Feb. 26, 2024 (CN) 202410211738.6

(51) Int. Cl. G06F 3/044; G06F 3/041

(52) U.S. Cl. CPC G06F 3/0446; G06F 3/0416; G06F 3/0442; G06F 3/0445; G06F 2203/04111

(57) ABSTRACT

A touch display panel and a display apparatus are provided. The touch display panel includes: a display substrate; a plurality of touch conductive layers located at a display side of the display substrate. An orthographic projection of the plurality of touch conductive layers on the display substrate is divided into a plurality of touch units arranged in an array along a first direction and a second direction, one touch unit of the touch units includes a plurality of touch sub-units arranged in n rows by n columns, where n is an integer greater than or equal to 2; the first direction intersects with the second direction; an extension direction of each row of touch sub-units is the first direction, and an extension direction of each column of touch sub-units is the second direction.

### CROSS-REFERENCE TO RELATED APPLICATION

The present disclosure is a National Stage of International Application No. PCT/CN2025/072573, filed on Jan. 15, 2025, which claims priority to Chinese Patent Applications No. 202410211738.6, filed with the China National Intellectual Property Administration on Feb. 26, 2024, and entitled “Touch Display Panel and Display Device”, the content of which is hereby incorporated by reference in its entirety.

### TECHNICAL FIELD

The present disclosure relates to the technical field of display, and particularly to a touch display panel and a display apparatus.

### BACKGROUND

With the development of touch technology, capacitive touch screen not only uses finger touch, but also uses stylus for touch. The stylus is divided into a passive stylus and an active stylus. Because of its small pen head, the active stylus has functions of pen pressure, floating touch control, button and so on, and has wider application scenarios and prospects than passive stylus.

With the development of active stylus technology, more and more touch screens, for example, mobile phones, laptops, tablets and other electronic products with touch screens are equipped with the active stylus, resulting in higher requirements for the performance of the active stylus. However, accuracy and linearity of touch control using active stylus in touch screens with medium and large size are crossed, affecting touch control performance.

### SUMMARY

Embodiments of the present disclosure provide a touch display panel and a display apparatus, to improve accuracy and linearity of touch control of the active stylus.

Embodiments of the present disclosure provide a touch display panel, including:
a display substrate; and
a plurality of touch conductive layers, located at a display side of the display substrate; where an orthographic projection of the plurality of touch conductive layers on the display substrate is divided into a plurality of touch units arranged in an array along a first direction and a second direction, one touch unit of the touch units includes a plurality of touch sub-units arranged in n rows by n columns, where n is an integer greater than or equal to 2; the first direction intersects with the second direction, an extension direction of each row of the touch sub-units is the first direction, and an extension direction of each column of the touch sub-units is the second direction; a width h1 of one touch sub-unit of the touch sub-units in the first direction, a width h2 of the touch sub-unit in the second direction, and a tip diameter D of the active stylus satisfy:

$$0.7 \leq \frac{h 1}{D} \leq 1.8 , 0.7 \leq \frac{h 2}{D} \leq 1.8 .$$

In some embodiments, 1 mm≤D≤1.2 mm; n=3, 1.2≤h1≤1.4, 1.2≤h2≤1.4.

In some embodiments, 1 mm≤D≤1.2 mm; n=4, 0.9≤h1≤1.05, 0.9≤h2≤1.05.

In some embodiments, 1.2 mm<D≤1.5 mm; n=3, 1.2≤h1≤1.4, 1.2≤h2≤1.4.

In some embodiments, 1.2 mm<D≤1.5 mm; n=2, 1.9≤h1≤2.1, 1.9≤h2≤2.1.

In some embodiments, one touch conductive layer of the touch conductive layers includes a metal grid structure formed by interweaving a plurality of metal lines;
the plurality of touch conductive layers include a first touch conductive layer and a second touch conductive layer; an orthographic projection of the first touch conductive layer on the display substrate and an orthographic projection of the second touch conductive layer on the display substrate have an overlapping region;
a line width of a metal line of the first touch conductive layer in the overlapping region is less than a line width of a metal line of the first touch conductive layer in a remaining region;
a line width of a metal line of the second touch conductive layer in the overlapping region is less than a line width of a metal line of the second touch conductive layer in a remaining region.

In some embodiments, the touch sub-unit includes a first electrode structure and a second electrode structure intersecting with each other; the first electrode structure includes two first sub-electrodes arranged along the second direction, and a bridging electrode electrically connecting the two first sub-electrodes; the second electrode structure includes two second sub-electrodes arranged along the first direction;
the first sub-electrode and the second sub-electrode are located in the same touch conductive layer, and the bridging electrode is located in a different touch conductive layer from the first sub-electrode and the second sub-electrode;
an orthographic projection of the bridging electrode on the display substrate overlaps with an orthographic projection of the second sub-electrode on the display substrate.

In some embodiments, the touch unit includes n rows of second electrode structures and n columns of first electrode structures;
a plurality of rows of the second electrode structures in the same row of the touch units are electrically connected with each other, and a plurality of columns of the first electrode structures in the same column of the touch units are electrically connected with each other;
or, a plurality of rows of the second electrode structures in the same row of the touch units are used for accessing the same touch signal, and a plurality of columns of the first electrode structures in the same column of the touch units are used for accessing the same touch signal.

In some embodiments, the touch conductive layer includes metal lines;
the bridging electrode includes m metal lines arranged along the first direction; where m is an integer greater than 2.

In some embodiments, the touch conductive layer includes metal lines;
the orthographic projection of the bridging electrode on the display substrate and the orthographic projection of the second sub-electrode on the display substrate have an overlapping region, and the second sub-electrode includes k metal lines arranged along the second direction; where k is an integer greater than 2.

In some embodiments, the touch conductive layer includes metal lines with an extension direction intersecting with both the first direction and the second direction;
a shape enclosed by orthographic projections of metal lines of the bridging electrode on the display substrate is a rectangle.

In some embodiments, a distance between the first sub-electrode and the second sub-electrode is greater than or equal to 40 micrometers and less than or equal to 80 micrometers.

In some embodiments, an outline of the touch sub-unit is a rectangle;
each of an outline of the first sub-electrode close to the second sub-electrode and an outline of the second sub-electrode close to the first sub-electrode is a broken line.

In some embodiments, each of the outline of the first sub-electrode close to the second sub-electrode and the outline of the second sub-electrode close to the first sub-electrode includes a plurality of first line segments and second line segments alternately arranged, the first line segments extend along the first direction, and the second line segments extend along the second direction.

In some embodiments, the first sub-electrode includes a first rectangular region and a first region located at a side of the first rectangular region in the second direction;
the second sub-electrode includes a second rectangular region and a second region located at a side of the second rectangular region in the first direction;
an outline of a pattern formed by two first regions located between two first rectangular regions in the second direction and two second regions located between two second rectangular regions in the first direction is a rectangle.

Embodiments of the present disclosure provide a display apparatus, including the touch display panel according to embodiments of the present disclosure.

### BRIEF DESCRIPTION OF FIGURES

In order to illustrate technical solutions in embodiments of the present disclosure more clearly, accompanying drawings that need to be used in describing embodiments will be introduced below briefly. Obviously, the accompanying drawings described below are only some embodiments of the present disclosure, and other accompanying drawings can also be obtained by those ordinary skilled in the art according to these accompanying drawings without creative labor.

FIG. 1 is a schematic structural diagram of a touch display panel according to an embodiment of the present disclosure;

FIG. 2 is an enlarged schematic view of a touch unit in a structure of a touch display panel according to an embodiment of the present disclosure;

FIG. 3 is a schematic structural diagram of another touch display panel according to an embodiment of the present disclosure;

FIG. 4 is a schematic structural diagram of another touch display panel according to an embodiment of the present disclosure;

FIG. 5 is a sectional view taken along EE′ in FIG. 4 according to an embodiment of the present disclosure;

FIG. 6 is a sectional view taken along FF′ in FIG. 4 according to an embodiment of the present disclosure;

FIG. 7 is a schematic structural diagram of a touch display panel in related art;

FIG. 8 is a schematic diagram of positions of standard coordinates and algorithm coordinates of a touch display panel in the related art;

FIG. 9 is a schematic diagram of positions of standard coordinates and algorithm coordinates of a touch display panel according to an embodiment of the present disclosure;

FIG. 10 is a schematic structural diagram of another touch display panel according to an embodiment of the present disclosure;

FIG. 11 is a schematic structural diagram of another touch display panel according to an embodiment of the present disclosure;

FIG. 12 is a schematic structural diagram of another touch display panel according to an embodiment of the present disclosure;

FIG. 13 is a schematic structural diagram of another touch display panel according to an embodiment of the present disclosure;

FIG. 14 is a schematic structural diagram of another touch display panel according to an embodiment of the present disclosure;

FIG. 15 is a schematic structural diagram of another touch display panel according to an embodiment of the present disclosure;

FIG. 16 is a schematic structural diagram of another touch display panel according to an embodiment of the present disclosure;

FIG. 17 is a schematic structural diagram of another touch display panel according to an embodiment of the present disclosure;

FIG. 18 is a schematic diagram of electrical connection of a first electrode structure or a second electrode structure of a touch display panel according to an embodiment of the present disclosure;

FIG. 19 is a schematic structural diagram of another touch display panel according to an embodiment of the present disclosure;

FIG. 20 is a schematic diagram of electrical connection of a first electrode structure or a second electrode structure of another touch display panel according to an embodiment of the present disclosure;

FIG. 21 is a schematic structural diagram of another touch display panel according to an embodiment of the present disclosure;

FIG. 22 is a schematic structural diagram of another touch display panel according to an embodiment of the present disclosure.

### DETAILED DESCRIPTION

For making objectives, technical solutions and advantages of embodiments of the present disclosure clearer, technical solutions of embodiments of the present disclosure will be clearly and completely described below in conjunction with accompanying drawings in embodiments of the present disclosure. Apparently, embodiments described are some rather than all of embodiments of the present disclosure. Embodiments in the present disclosure and features of embodiments may be combined with each other without conflict. Based on embodiments of the present disclosure, all other embodiments obtained by those of ordinary skill in the art without making creative efforts fall within the scope of protection of the present disclosure.

Unless otherwise defined, technical or scientific terms used in the present disclosure should have ordinary meanings as understood by those of ordinary skill in the art to which the present disclosure belongs. The words “first”, “second”, etc. used in the present disclosure do not indicate any order, quantity or importance, but are only used to distinguish different components. The word “including” or “comprising”, etc. indicates that elements or objects before the word include elements or objects after the word and their equivalents, without excluding other elements or objects. The word “connection” or “link”, etc. is not limited to physical or mechanical connections, but may include electrical connections, whether direct or indirect.

It should be noted that a size and a shape of each figure in the drawings do not reflect a true scale, but only for illustrating the present disclosure. Throughout the drawings, identical or similar reference numerals denote identical or similar elements or elements having identical or similar functions.

In the related art, a difference between a diameter of a tip of the active stylus and a size of a touch sub-unit is large. When the active stylus is used for touch operation on the touch display panel, signal amount sensed by a touch electrode in different regions may have sudden changes. As a result, there is a large deviation between an actually sensed touch position and an actual touch position, and the touch accuracy and linearity are poor.

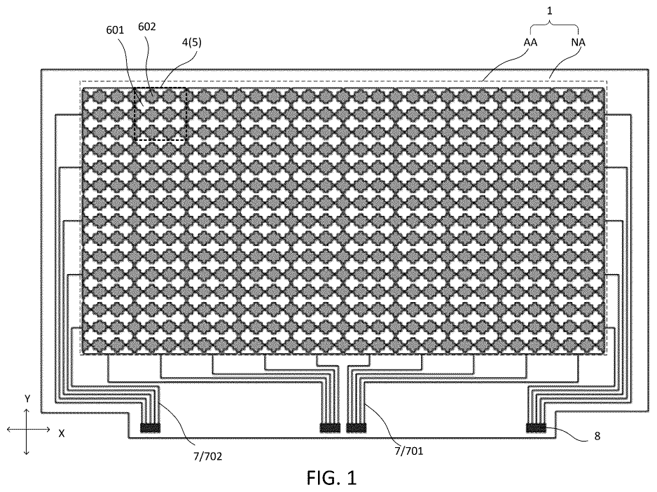

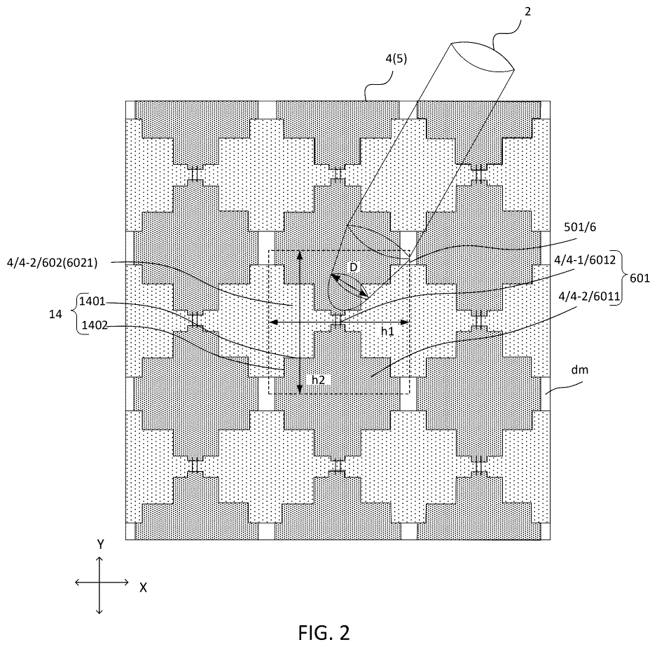

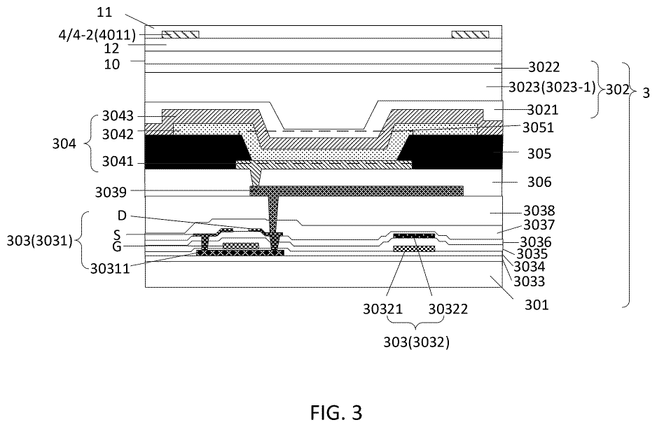

Embodiments of the present disclosure provide a touch display panel 1. As shown in FIG. 1, FIG. 2, and FIG. 3, the touch display panel 1 performs touch control based on the active stylus 2.

The touch display panel 1 includes:
a display substrate 3;
a plurality of touch conductive layers 4, located at a display side of the display substrate 3.
   An orthographic projection of the plurality of touch conductive layers 4 on the display substrate 3 is divided into a plurality of touch units 5 arranged in an array along a first direction X and a second direction Y. One touch unit of the touch units 5 includes a plurality of touch sub-units 501 arranged in n rows by n columns, where n is an integer greater than or equal to 2. The first direction X intersects the second direction Y, an extension direction of each row of the touch sub-units 501 is the first direction X, and an extension direction of each column of the touch sub units 501 is the second direction Y. A width h1 of one touch sub-unit 501 of the touch sub-units 501 in the first direction X, a width h2 of the touch sub-unit 501 in the second direction Y, and a tip diameter D of the active stylus satisfy:

$$0.7 \leq \frac{h 1}{D} \leq 1.8 , 0.7 \leq \frac{h 2}{D} \leq 1.8 .$$

It should be noted that when

$$\frac{h 1}{D}$$

is less than 0.7, and

$$\frac{h 2}{D}$$

is less than 0.7, the tip diameter of the active stylus is larger than the width of the touch sub-unit in the first direction and the width of the touch sub-unit in the second direction, and a size difference between the size of the touch sub-unit and the tip diameter of the active stylus is too large. When the active stylus used for touch control passes through different regions, there may be a large deviation between an actually sensed touch position and an actual touch position caused by a sudden change of a signal amount. Similarly, when

$$\frac{h 1}{D}$$

is greater than 1.8, and

$$\frac{h 2}{D}$$

is greater than 1.8, the width of the touch sub-unit in the first direction and the width of the touch sub-unit in the second direction are larger than the tip diameter of the active stylus, and the size difference between the size of the touch sub-unit and the tip diameter of the active stylus is too large. When the active stylus used for touch control passes through different regions, there may be a large deviation between the actually sensed touch position and the actual touch position caused by the sudden change of the signal amount. In the touch display panel according to an embodiment of the present disclosure, when

$$\frac{h 1}{D}$$

is equal to 0.7, and

$$\frac{h 2}{D}$$

is equal to 0.7, even if the tip diameter of the active stylus is larger than the width of the touch sub-unit in the first direction and the width of the touch sub-unit in the second direction, because the size difference between the tip diameter of the active stylus and the size of the touch sub-unit is small, sudden change of the signal amount cannot occur when the active stylus passe through different regions. The deviation between the actually sensed touch position and the actual touch position is not large. Similarly, when

$$\frac{h 1}{D}$$

is equal to 1.8, and

$$\frac{h 2}{D}$$

is equal to 1.8, even if the width of the touch sub-unit in the first direction and the width of the touch sub-unit in the second direction are larger than the tip diameter of the active stylus, because the size difference between the tip diameter of the active stylus and the size of the touch sub-unit is small, sudden change of the signal amount cannot when that active stylus passe through different regions. The deviation between the actually sensed touch position and the actual touch position is not large. When

$$0.7 \leq \frac{h 1}{D} \leq 1.8 , 0.7 \leq \frac{h 2}{D} \leq 1.8 ,$$

the difference between the size of the touch sub-unit and the tip diameter of the active stylus is small, sudden change of the signal amount when the active stylus passes through different regions can be avoided. The large deviation between the actually sensed touch position and the actual touch position is avoided, and the touch accuracy and linearity can be improved.

It should be noted that FIG. 2 is an enlarged schematic view of a touch unit.

It should be noted that a tip of the active stylus is a part of a spherical surface, and the tip diameter of the active stylus refers to a diameter of the spherical surface.

In some embodiments, h1=h2.

In some embodiments, 1 mm≤D≤1.2 mm; n=3, 1.2≤h1≤1.4, 1.2≤h2≤1.4.

In some embodiments, 1 mm≤D≤1.2 mm; n=4, 0.9≤h1≤1.05, 0.9≤h2≤1.05.

In some embodiments, 1.2 mm<D≤1.5 mm; n=3, 1.2≤h1≤1.4, 1.2≤h2≤1.4.

In some embodiments, 1.2 mm<D≤1.5 mm; n=2, 1.9≤h1≤2.1, 1.9≤h2≤2.1.

In some embodiments, as shown in FIG. 2, the touch sub-unit 501 includes a first electrode structure 601 and a second electrode structure 602 arranged intersecting with each other, i.e., the first electrode structure 601 and the second electrode structure 602 form a bridging structure 6. The first electrode structure 601 includes two first sub-electrodes 6011 arranged along the second direction Y, and a bridging electrode 6012 electrically connecting the two first sub-electrodes 6011. The second electrode structure 602 includes two second sub-electrodes 6021 arranged along the first direction X.

The first sub-electrode 6011 and the second sub-electrode 6021 are located in the same touch conductive layer 4. The bridging electrode 6012 is located in a different touch conductive layer 4 from the first sub-electrode 6011 and the second sub-electrode 6021.

An orthographic projection of the bridging electrode 6012 on the display substrate 3 overlaps with an orthographic projection of the second sub-electrode 6021 on the display substrate 3.

In some embodiments, as shown in FIG. 2, two adjacent first sub-electrodes 6011 located in different bridging structures 6 are integrally connected.

The second sub-electrodes 6021 in the same row are integrally connected.

In some embodiments, the touch unit 5 includes n rows of second electrode structures 602 and n columns of first electrode structures 601.

In some embodiments, a plurality of rows of second electrode structures 602 in the same row of touch units 5 are electrically connected with each other. A plurality of columns of first electrode structures 601 in the same column of touch units 5 are electrically connected with each other.

Alternatively, a plurality of rows of second electrode structures 602 in the same row of touch units 5 are used for accessing the same touch signal. A plurality of columns of first electrode structures 601 in the same column of touch units 5 are used for accessing the same touch signal.

In a specific implementation, the plurality of rows of the second electrode structures 602 in the same row of the touch units 5 are electrically connected with each other, and the plurality of columns of the second electrode structures 602 in the same column of the touch units 5 are electrically connected with each other, so that the plurality of rows of second electrode structures 602 in the same row of touch units 5 can access the same touch signal, and the plurality of columns of first electrode structures 601 in the same column of touch units 5 access the same touch signal.

In a specific implementation, if the plurality of rows of second electrode structures 602 in the same row of touch units 5 are not electrically connected with each other, and the plurality of columns of the second electrode structures 602 in the same column of the touch units 5 are not electrically connected with each other, the plurality of rows of second electrode structures 602 in the same row of touch units 5 are connected with the same touch signal, so that the plurality of columns of first electrode structures 601 in the same column of touch units 5 access the same touch signal.

In some embodiments, as shown in FIG. 1, the touch display panel 1 includes a display region AA and a peripheral region NA surrounding the display region AA. The touch units 5 are located in the display region AA.

The touch display panel 1 further includes a plurality of bonding electrodes 8 located in the peripheral region NA and a plurality of touch signal lines 7. One touch signal line 7 of the touch signal lines 7 extends from the display region AA to the peripheral region NA. One end of the touch signal line 7 is electrically connected with one touch unit 5 of the touch units 5, and the other end of the touch signal line 7 is electrically connected with one bonding electrode 8 of the bonding electrodes 8.

In a specific implementation, the bonding electrode is used for bonding with a driving chip.

In some embodiments, as shown in FIG. 1, the plurality of touch signal lines 7 include a plurality of first touch signal lines 701 and a plurality of second touch signal lines 702. One first touch signal line 701 of the first touch signal lines 701 is electrically connected with a plurality of columns of first electrode structures 601 in a column of touch units 5. One second touch signal line 702 of the touch signal lines 7 is electrically connected with a plurality of rows of second electrode structures 602 in a row of touch units 5.

In some embodiments, as shown in FIG. 1, two ends of a row of touch units 5 are electrically connected with two second touch signal lines 702 respectively. One end of a column of touch units 5 near the bonding electrode 8 is electrically connected with the first touch signal line 701.

In some embodiments, the display region includes a plurality of sub-pixels. The plurality of sub-pixels include, for example, a plurality of red sub-pixels, a plurality of blue sub-pixels, and a plurality of green sub-pixels.

In some embodiments, as shown in FIG. 3, the display substrate 3 includes a base substrate 301, a driving circuit layer 303 located at a side of the base substrate 301, a pixel defining layer 305 and a plurality of light-emitting device 304 at a side of the driving circuit layer 303 away from the base substrate 301, and an encapsulation layer 302 located at a side of the light-emitting devices 304 away from the substrate. The light-emitting devices 304 are in one-to-one correspondence with the sub-pixels.

In some embodiments, as shown in FIG. 3, one light-emitting device 304 of the light-emitting devices 304 includes an anode 3041, a light-emitting functional layer 3042 and a cathode 3043. The pixel defining layer 305 includes a plurality of sub-pixel opening regions 3051. The pixel defining layer 305 covers an edge of the anode 3041. An orthographic projection of a sub-pixel opening region 3051 of the sub-pixel opening regions 3051 on the base substrate 301 falls within an orthographic projection of the anode 3041 on the base substrate 301. The light-emitting functional layer 3042 is located at a side of the anode 3041 and the pixel defining layer 305 away from the base substrate 301. The cathode 3043 is located at a side of the light-emitting functional layer 3042 away from the base substrate 301.

In a specific implementation, if the light-emitting device is an organic light-emitting diode, the light-emitting functional layer at least includes an organic light-emitting layer, and may include at least one of an electron injection layer, a hole blocking layer, an electron transport layer, a hole transport layer, an electron blocking layer, a hole injection layer.

In some embodiments, as shown in FIG. 3, the driving circuit layer 303 includes pixel driving circuits corresponding to the light-emitting devices 304 one by one and drive the light-emitting devices 304 to emit light. One pixel driving circuit of the pixel driving circuits includes, for example, a thin film transistor 3031 and a capacitor 3032. It should be noted that only one thin film transistor 3031 and one capacitor 3032 are shown in FIG. 3. In a specific implementation, the pixel driving circuit may further include a greater quantity of thin film transistors and capacitors.

It should be noted that in FIG. 3, the thin film transistor 3031 is illustrated as a top-gate structure. That is, a gate G is located at a side of an active layer 30311 away from the substrate 301. A first electrode 30321 of the capacitor 3032 is arranged in the same layer as the gate G. A second electrode 30322 of the capacitor 3032 is located between a film layer where the gate G is located and a film layer where a source S and a drain D are located. The display substrate 3 further includes a first buffer layer 3033 located between the base substrate 301 and the active layer 30311, a first gate insulating layer 3034 located between the gate G and the active layer 30311, a second gate insulating layer 3035 located between the first electrode 30321 and the second electrode 30322, an interlayer insulating layer 3036 located between the second electrode 30322 and the source S and drain D, and a first planarization layer 306 located between the source S and drain D and the anode 3041.

In some embodiments, the anode is lapped with the drain through a through hole penetrating the first planarization layer.

Alternatively, in some embodiment, as shown in FIG. 3, the display substrate 3 further includes a transfer electrode 3039 located between the source S and the drain D and the anode electrode 3041, a passivation layer 3037 located between the source S and drain D and the transfer electrode 3039, and a second planarization layer 3038 located between the passivation layer 3037 and the transfer electrode 3039. The anode 3041 is lapped with the transfer electrode 3039 through a through hole penetrating the first planarization layer 306. The transfer electrode 3039 is lapped with the drain D through a through hole penetrating the second planarization layer 3038 and the passivation layer 3037.

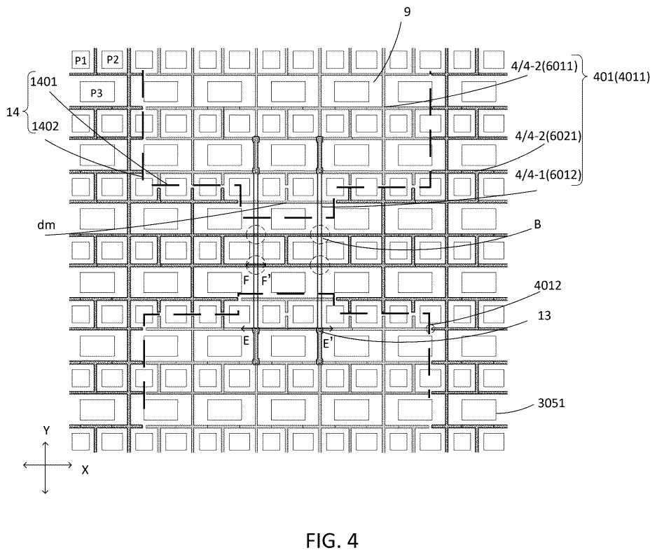

In some embodiments, as shown in FIGS. 4-6, the plurality of touch conductive layers 4 include a first touch conductive layer 4-1 and a second touch conductive layer 4-2. The second touch conductive layer 4-2 is located at a side of the first touch conductive layer 4-1 away from the display substrate 3. For example, the bridging electrode 6012 is located in the first touch conductive layer 4-1. The first sub-electrode 6011 and the second sub-electrode 6021 are located in the second touch conductive layer 4-2.

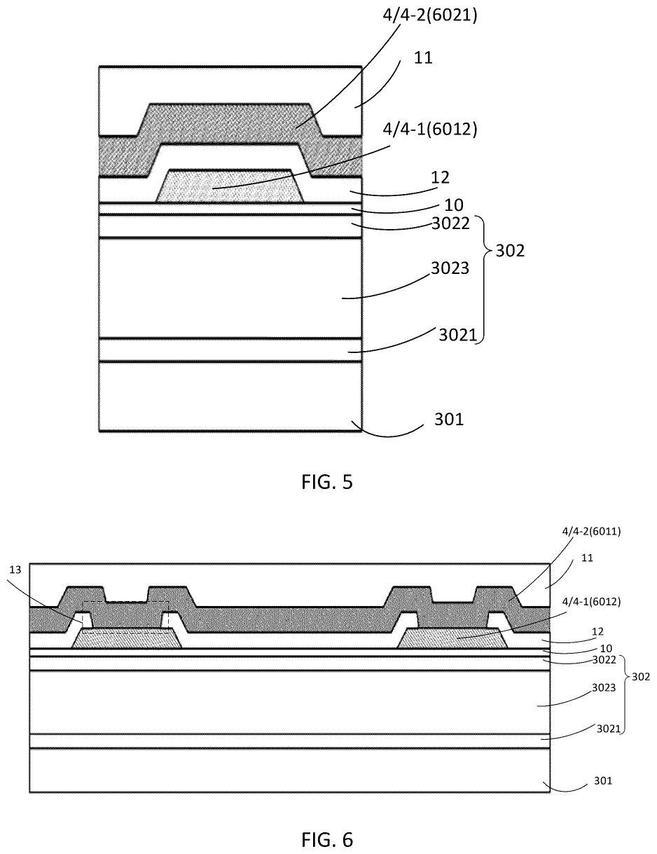

It should be noted that FIG. 5 is a sectional view taken along EE′ in FIG. 4, and FIG. 6 is a sectional view taken along FF′ in FIG. 4. In FIGS. 5 and 6, film layers between the base substrate 301 and the encapsulation layer 302 are omitted.

In some embodiments, as shown in FIGS. 5 and 6, the touch display panel 3 further includes a second buffer layer 10 located between the first touch conductive layer 4-1 and the encapsulation layer 302, a touch insulating layer 12 located between the first touch conductive layer 4-1 and the second touch conductive layer 4-2, and a protective layer 11 located at a side of the second touch conductive layer 4-2 away from the base substrate 301.

The first sub-electrode 6011 is electrically connected with the bridging electrode 6012 through a through hole 13 penetrating the touch insulating layer 12.

The touch display panel according to an embodiment of the present disclosure adopts an FMLOC process, that is, the touch layer is directly manufactured on stacked light-emitting structure layer and encapsulation layer, so that a thickness of the touch display panel can be reduced, which is beneficial to realizing lightness and thinness of the touch display product.

In some embodiments, as shown in FIG. 4, one touch conductive layer of the touch conductive layers 4 includes a metal grid structure 401 formed by interweaving a plurality of metal lines 4011.

In some embodiments, as shown in FIG. 4, the metal grid structure 401 is formed by interweaving a plurality of metal lines 4011, so that the metal grid structure 401 includes a plurality of grids 9. That is, one grid of the grids 9 is a polygon composed of a plurality of metal lines, or, the metal grid structure 401 is formed by repeatedly and continuously arranging and splicing the grids 9. As shown in FIG. 4, a shape of the grid 9 surrounded by the metal lines 4011 is a rectangle. Alternatively, the shape of the grid surrounded by the metal lines may be a rhombus, triangle, hexagon, etc., or, the shape of the grid surrounded by the metal lines may be a combination of various shapes, such as a combination of pentagon and hexagon, or, the shape of the grid surrounded by the metal lines may include any one or more of triangle, square, rectangle, rhombus, trapezoid, pentagon, and hexagon. In a specific implementation, a pattern of the grid surrounded by the metal lines can be a regular shape or an irregular shape. An edge of the grid may be a straight line or may be a curved line, and embodiments of the present disclosure are not limited herein. The edge of the metal grid structure may also include a pattern of incomplete grids.

In a specific implementation, as shown in FIG. 4, a plurality of cutouts 4012 can be arranged on the grid 9. For parts of the touch conductive layer 4 in the same layer that need to be insulated from each other, for example, when the grid 9 of the first sub-electrode 6011 and the grid 9 of the second sub-electrode 6021 are located in the same layer, by providing the cutouts 4012 in the pattern of the grid 9 provided on the entire surface, isolation between the grid 9 of the first sub-electrode 6011 and the grid 9 of the second sub-electrode 6021 can be realized.

The touch electrode and the touch signal line according to an embodiment of the present disclosure include a metal grid structure. The touch conductive layer with a metal grid structure has advantages of small resistance, small thickness, high response speed and the like. Sensitivity and accuracy of touch recognition can be improved in addition, cutouts 4012 are provided in the pattern of the grid 9 provided on the entire surface, to realize isolation between the grid 9 of the first sub-electrode 6011 and the grid 9 of the second sub-electrode 6021, and further improve a shadow eliminate effect of the metal line in a screen off state.

In some embodiments, as shown in FIG. 4, the orthographic projection of the sub-pixel opening region 3051 on the base substrate falls within the orthographic projection of the grid 9 on the base substrate 301. That is, the orthographic projection of the metal line 4011 on the base substrate and the orthographic projection of the sub-pixel opening region 3051 on the base substrate are not overlapped. Therefore, the metal line 4011 can be prevented from affecting normal display of the display substrate.

In some embodiments, as shown in FIG. 2 and FIG. 4, an outline of the touch sub-unit 501 is a rectangle.

Each of an outline of the first sub-electrode 6011 close to the second sub-electrode 6021 and an outline of the second sub-electrode 6021 close to the first sub-electrode 6011 is a broken line 14.

In some embodiments, as shown in FIG. 4, by providing cutouts 4012 in the grid 9, to realize isolation between the grid 9 of the first sub-electrode 6011 and the grid 9 of the second sub-electrode 6021, a connecting line of the cutouts 4012 is the outline of the first sub-electrode 6011 close to the second sub-electrode 6021, and the outline of the second sub-electrode 6021 close to the first sub-electrode 6011. That is, the connecting line of the cutouts 4012 is the broken line 14.

In some embodiments, as shown in FIGS. 2 and 4, each of the outline of the first sub-electrode 6011 close to the second sub-electrode 6021 and the outline of the second sub-electrode 6021 close to the first sub-electrode 6011 includes a plurality of first line segments 1401 and second line segments 1402 alternately arranged. The first line segment 1401s extend along the first direction X, and the second line segments 1402 extend along the second direction Y.

In some embodiments, a sum of a quantity of first line segments and a quantity of second line segments included in the broken line is greater than two. For example, as shown in FIG. 2, the sum of the quantity of the first line segments 1401 and the quantity of the second line segments 1402 included in the broken line 14 is 8.

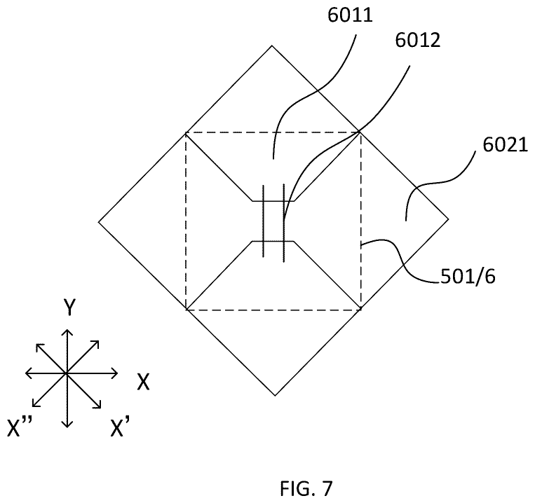

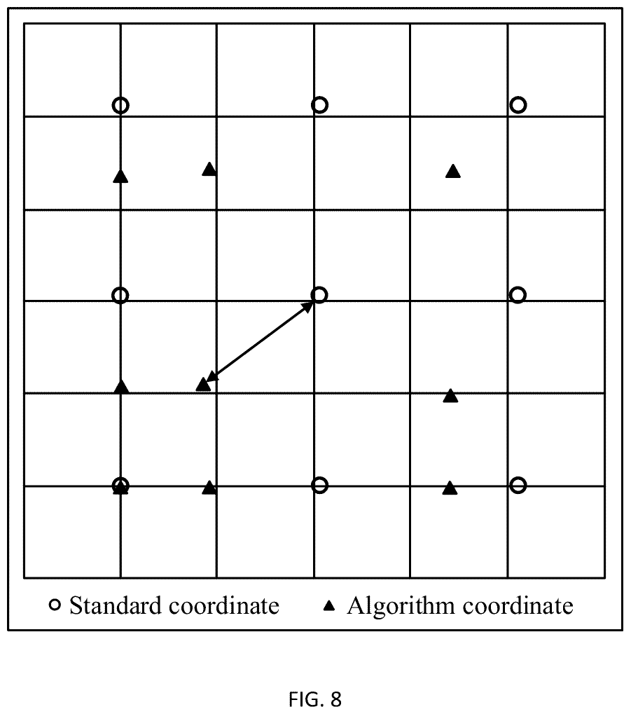

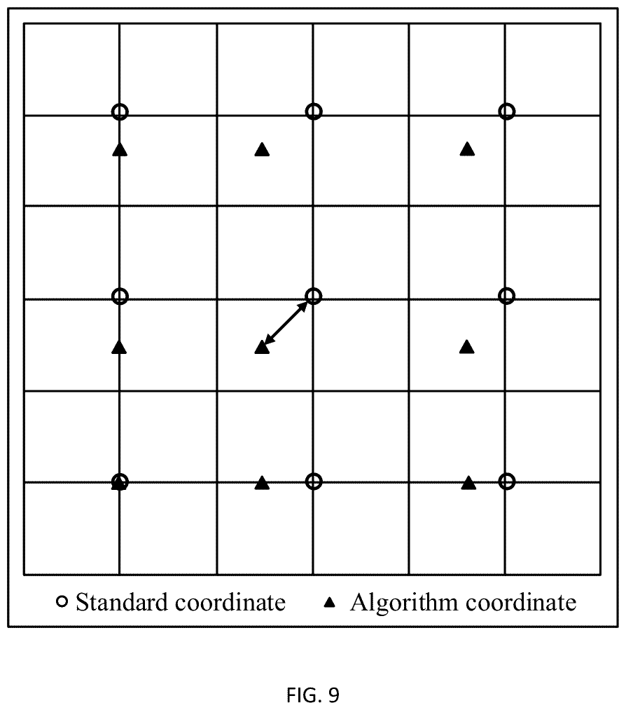

It should be noted that in the related art, as shown in FIG. 7, an outline of adjacent two first sub-electrodes 6011 is substantially rhombic. An outline of adjacent two second sub-electrodes 6021 is approximately rhombic. That is, most regions of the outline of the first sub-electrode 6011 close to the second sub-electrode 6021 and the outline of the second sub-electrode 6021 close to the first sub-electrode 6011 are oblique line extending along a third direction X′ or a fourth direction X″. The third direction X′ intersects with the fourth direction X″. The third direction X′ intersects with both the first direction X and the second direction Y. The fourth direction X″ intersects with both the first direction X and the second direction Y. For touch electrodes with a rhombic outline, algorithm coordinates (triangle positions in FIG. 8) calculated through an algorithm and standard coordinates (circular positions in FIG. 8) of actual touch positions of an active stylus are shown in FIG. 8. For the touch display panel according to an embodiment of the present disclosure, algorithm coordinates (triangle positions in FIG. 9) calculated through an algorithm and standard coordinates (circular position in FIG. 9) of actual touch positions of the active stylus is shown in FIG. 9. The greater the distance between the triangle position and the circular position, the greater the touch deviation, and the worse the touch accuracy and linearity. On the contrary, the less the distance between the triangle position and the circular position, the better the touch accuracy and linearity. For electrodes with a rhombic outline, because a difference between a signal amount of the first sub-electrode and a signal amount of the second sub-electrode at different positions of the tip of the active stylus is larger, as shown in FIG. 8, the touch deviation is large. For the touch control display panel according to an embodiment of the disclosure, a difference between the size of the touch sub-unit and the tip diameter of the active stylus is small, and the outline of the first sub-electrode close to the second sub-electrode and the outline of the second sub-electrode close to the first sub-electrode are arranged to be a plurality of broken lines, to further reduce the difference between the signal amount of the first sub-electrode and the signal amount of the second sub-electrode at different positions of the tip of the active stylus. As shown in FIG. 9, the touch deviation is small, and the touch accuracy and linearity can be improved.

It should be noted that in FIG. 2, the sum of the quantity of the first line segments 1401 and the quantity of the second line segments 1402 included in the broken line 14 is 8 is taken as an example for illustration. An outline shape of a pattern formed by two first sub-electrodes 6011 and an outline shape of a pattern formed by two second sub-electrodes 6021 are approximately a cross type. Of course, when the broken line includes a plurality of first line segments and second line segments alternately arranged, the first sub-electrode and the second sub-electrode may have other patterns.

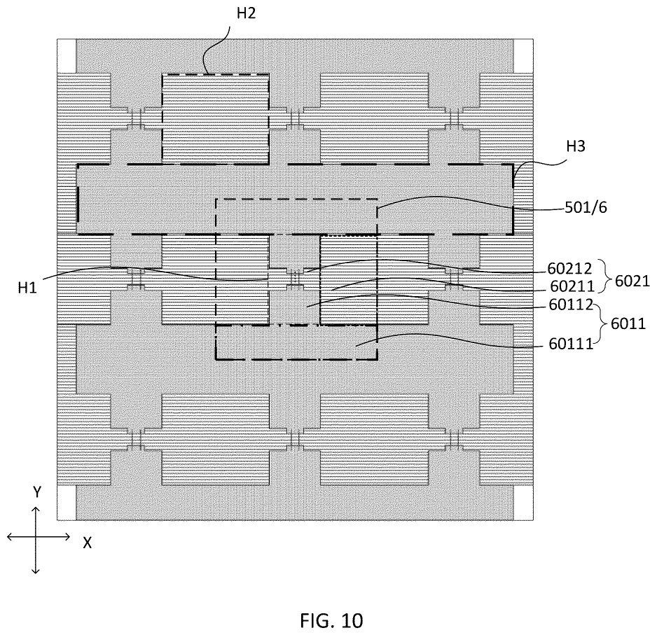

In some embodiments, as shown in FIG. 10, the first sub-electrode 6011 includes a first rectangular region 60111 and a first region 60112 located at a side of the first rectangular region 60111 in the second direction Y.

The second sub-electrode 6021 includes a second rectangular region 60211 and a second region 60212 located at a side of the 60211 of the second rectangular region in the first direction X.

An outline of a pattern formed by two first regions 60112 located between two first rectangular regions 60111 in the second direction Y and two second regions 60212 located between two second rectangular regions 106211 in the first direction X is a rectangle.

In some embodiments, as shown in FIG. 10, a width of a H1 region in the second direction Y is equal to a width of the second rectangular region 60211 in the second direction Y.

In some embodiments, as shown in FIG. 10, two adjacent second rectangular regions 60211 located in different touch sub-units 501 constitute a third rectangular region H2. A plurality of first rectangular regions 60111 located between adjacent two rows of the second rectangular regions 60211 constitute a fourth rectangular region H3.

In a specific implementation, as shown in FIG. 4, an orthographic projection of the metal lines 4011 in the first touch conductive layer 4-1 on the display substrate (not shown) and an orthographic projection of the metal lines 4011 in the second touch conductive layer 4-2 on the display substrate have a coincident region. An orthographic projection of the bridging electrode 6012 on the display substrate (not shown) and an orthographic projection of the second sub-electrode 6021 on the display substrate have an overlapping region B. A line width of the metal line 4011 in any region is uniform. The grid 9 in the first touch conductive layer 4-1 and the grid 9 in the second touch conductive layer 4-2 have the same shape, size, and line width of the metal line 4011.

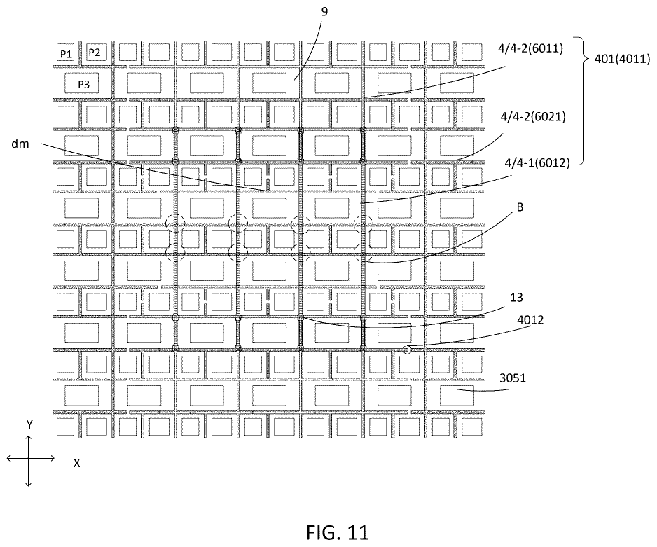

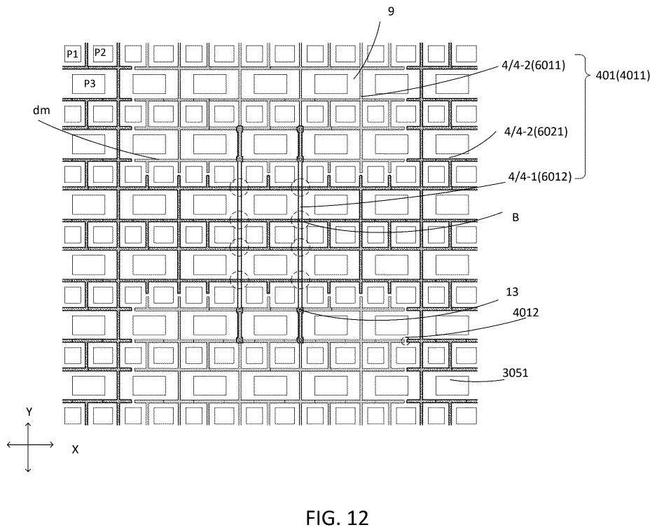

In some embodiments, as shown in FIGS. 11-13, an orthographic projection of the first touch conductive layer 4-1 on the display substrate (not shown) and an orthographic projection of the second touch conductive layer 4-2 on the display substrate (not shown) have an overlapping region B. That is, the orthographic projection of the bridging electrode 6012 on the display substrate (not shown) and the orthographic projection of the second sub-electrode 6021 on the display substrate (not shown) have an overlapping region B.

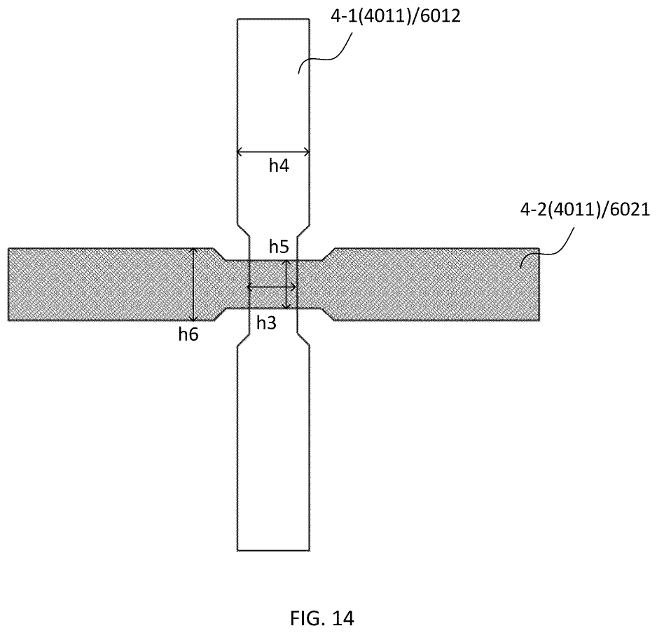

In some embodiments, as shown in FIG. 14, a line width h3 of the metal line 4011 (the metal line 4011 of the bridging electrode 6012) of the first touch conductive layer 4-1 in the overlapping region B is less than a line width h4 of the metal line 4011 (the metal line 4011 of the bridging electrode 6012) of the first touch conductive layer 4-1 in a remaining region. A line width h5 of the metal line 4011 (the metal line 4011 of the second sub-electrode 6021) of the second touch conductive layer 4-2 in the overlapping region is less than a line width h6 of the metal line 4011 (the metal line 4011 of the second sub-electrode 6021) of the second touch conductive layer 4-2 in a remaining region.

In the touch display panel according to an embodiment of the present disclosure, the line width of the metal line in the overlapping region is reduced, so that parasitic capacitance between two layers of metal lines in the overlapping region can be reduced, and the touch accuracy can be improved.

In some embodiments, h3=h4−1 micrometers and h5=h6−1 micrometers.

In the related art, resistance and capacitance of a path of a touch electrode of a large-size touch display panel are increased along with the increase of a screen body, and impedance is increased, causing RC Loading to increase. A signal of the active stylus is transmitted through the coupling capacitance between the stylus and the touch electrode, reaches an operational amplifier of the driving chip (IC) after passing through the RC loading of the touch display panel and is output. An increase in RC Loading results in an increase in signal attenuation of the active stylus, which seriously hinders the application of active stylus in medium and large size touch products.

In some embodiments, as shown in FIG. 11 to FIG. 13, the bridging electrode 6012 includes m metal lines 4011 arranged along the first direction X, and m is an integer greater than 2; and/or, the orthographic projection of the bridging electrode 6012 on the display substrate 3 and the orthographic projection of the second sub-electrode 6021 on the display substrate 3 have an overlapping region. The second sub-electrode 6021 includes k metal lines 4011 arranged along the second direction Y, and k is an integer greater than 2.

In some embodiments, as shown in FIG. 11 to FIG. 13, the touch conductive layer 4 includes metal lines 4011 extending along the first direction X and metal lines 4011 extending along the second direction Y.

In the touch display panel according to an embodiment of the present disclosure, m is greater than 2 and/or k is greater than 2. Therefore, the impedance of the first electrode structure and the second electrode structure can be reduced.

In some embodiments, m=4 and k=2 in FIG. 11.

In some embodiments, m=2 and k=4 in FIG. 12.

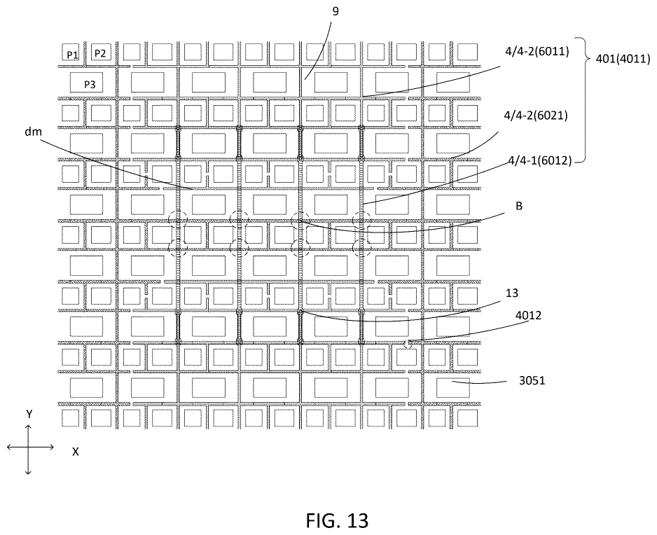

In some embodiments, m=4 and k=4 in FIG. 13.

In a specific implementation, when both m and k are greater than 2, compared with the case that one of m and k is less than or equal to 2, the impedance of the two second sub-electrodes in the touch sub-unit can be further reduced, the signal attenuation of the active stylus is reduced, and the touch signal amount is increased.

Next, the impedance of the first electrode structure and the second electrode structure can be reduced by increasing the quantity of metal lines in the overlapping region. As shown in Table 1, when m=2 and k=2, the impedance of the first electrode structure is 6.67 ohms (Q), and the impedance of the second electrode structure is 4.830. When m=4 and k=4, the impedance of the first electrode structure is 4.720, which is 29% lower than that when m=2 and k=2. The impedance of the second electrode structure is 3.140, which is 35% lower than that of m=2.

TABLE 1

| | | | Impedance |
|---|---|---|---|
| m, k | 2 | 4 | reduction benefit |
| Impedance of first electrode | 6.67 | 4.72 | (6.67 − 4.72)/6.67 = |
| structure (Ω) | | | 29% |
| Impedance of second electrode | 4.83 | 3.14 | (4.83 − 3.14)/4.83 = |
| structure (Ω) | | | 35% |

In some embodiments, as shown in FIG. 11 to FIG. 13, a shape of an orthographic projection of the sub-pixel opening region 3051 on the display substrate (not shown) is a rectangle. One pair of sides of the rectangle is parallel to the first direction X, and the other pair of sides is parallel to the second direction Y. That is, a side of the sub-pixel opening region 3051 is parallel to the metal line 4011.

In a specific implementation, as shown in FIG. 11 to FIG. 13, the plurality of opening regions 3014 include a red sub-pixel opening region P2 corresponding to the red sub-pixel, a blue opening region P3 corresponding to the blue sub-pixel, and a green sub-pixel opening region P1 corresponding to the green sub-pixel. The green sub-pixel opening region P1 and the red sub-pixel opening region P2 are in the same row. The blue sub-pixel opening region P3 is located in a different row from the green sub-pixel opening region P1 and the red sub-pixel opening region P2. The blue sub-pixel open region P3 is staggered from the green sub-pixel opening region P1 and the red sub-pixel open region P2. A pixel includes, for example, a green sub-pixel opening region P1, a red sub-pixel opening region P2, and a blue sub-pixel opening region P3.

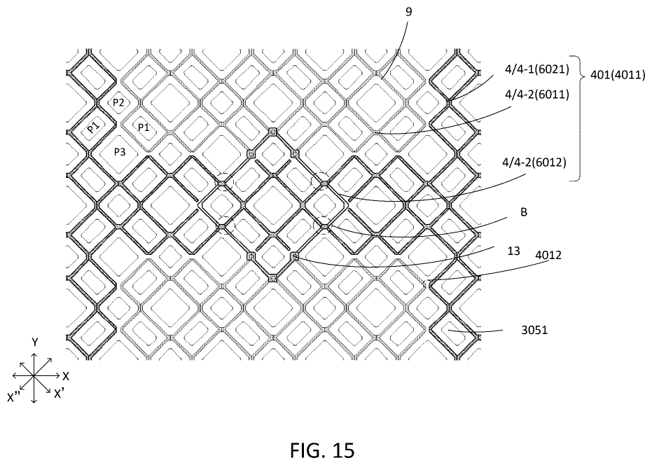

Alternatively, in some embodiment, as shown in FIG. 15, the touch conductive layer 4 includes metal lines 4011 with an extension direction intersecting with both the first direction X and the second direction Y.

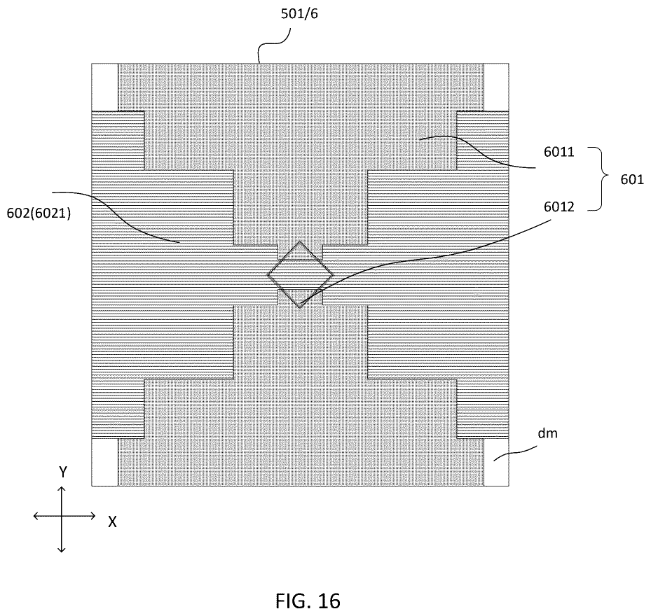

As shown in FIGS. 15 and 16, a shape enclosed by orthographic projections of metal lines 4011 of the bridging electrode 6012 on the display substrate 3 is a rectangle. In this way, the quantity of the metal lines included in the bridging electrode is still four, and the impedance of the first electrode structure can be reduced. In addition, when the four metal lines of the bridging electrode are enclosed into a rectangle, there are only four overlapping regions of the bridging electrode and the first sub-electrode in one touch sub-unit. That is, the overlapping region of the bridging electrode and the first sub-electrode can be reduced, the parasitic capacitance between the bridging electrode and the first sub-electrode is reduced, and the touch accuracy is improved.

In a specific implementation, as shown in FIG. 15, the shape of the sub-pixel opening region 3051 is a rectangle, and sides of the rectangle are parallel to the metal lines. The plurality of sub-pixel opening regions 3051 are arrayed along a third direction X′ and a fourth direction X″. The third direction X′ and the fourth direction X″ intersect with each other. The third direction X′ intersects with both the first direction X and the second direction Y. The fourth direction X″ intersects with both the first direction X and the second direction Y. A row of sub-pixel opening regions 3051 arranged along the third direction X′ includes green sub-pixel opening regions P1 and red sub-pixel openings alternately arranged. A row of sub-pixel opening regions 3051 adjacent to the above row of sub-pixel opening regions 3051 includes blue sub-pixel opening regions P3 and green sub-pixel opening regions P3 alternately arranged. A pixel includes, for example, two green sub-pixel opening regions P1, one red sub-pixel opening region P2, and one blue sub-pixel opening region P3.

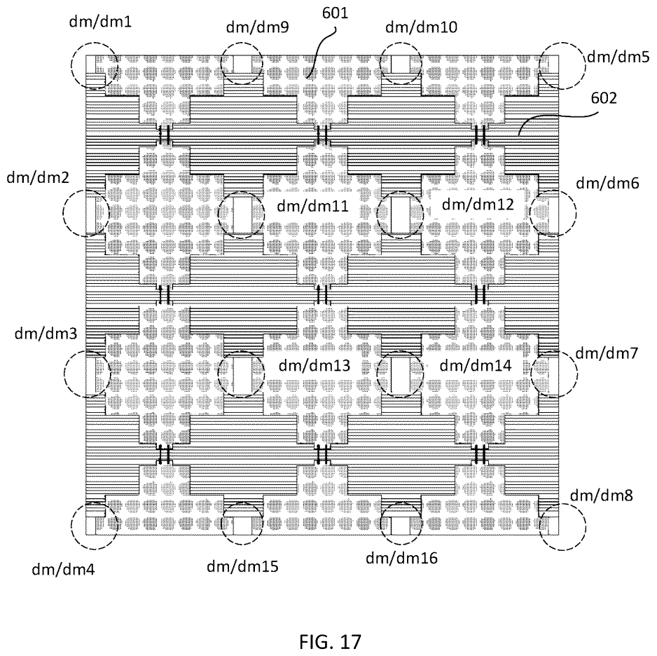

In the related art, as shown in FIG. 17, the touch conductive layer 4 where the first sub-electrode 6011 and the second sub-electrode 6021 are located further includes a dummy electrode dm. The dummy electrode dm is disconnected from both the first sub-electrode 6011 and the second sub-electrode 6021. At least part of dummy electrodes dm1 to dm16 are located between adjacent two rows of first sub-electrodes 6011, and/or located between adjacent two rows of second sub-electrodes 6012.

In a specific implementation, the dummy electrode also includes a metal line. Arrangement of the dummy electrode can ensure that the touch conductive layer includes a metal grid structure in any region of the display region, to improve display uniformity.

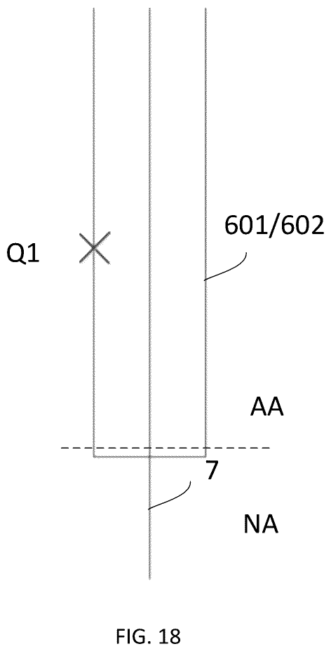

However, because a plurality of rows of second electrode structures in the same row of touch units are used for accessing the same touch signal, and a plurality of columns of first electrode structures in the same column of touch units are used for accessing the same touch signal, as shown in FIG. 18, a plurality of rows of second electrode structures 602 in the same row of touch units (not shown) or a plurality of columns of first electrode structures 601 (shown with one line segment) achieve electrical connection only in the peripheral region NA. That is, the plurality of rows of the second electrode structures 602 and the plurality of columns of the first electrode structures 601 are mutually independent in the display region AA, and are connected with the same touch signal line in the peripheral region NA. In this way, when a path of one row of the second electrode structures 602 in the display region AA is locally damaged (e.g., Q1 in FIG. 18) due to process or reliability condition, there may be floating in the corresponding path, causing capacitance of the whole path to be abnormal, affecting touch accuracy.

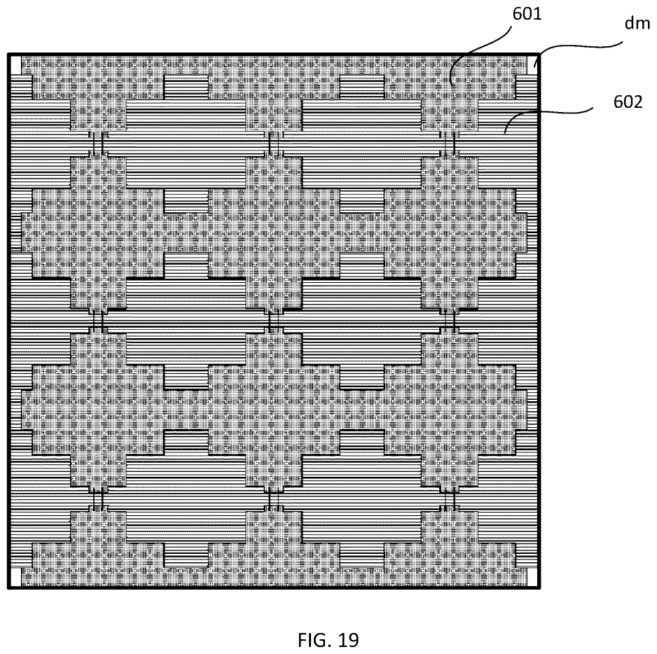

In some embodiments, as shown in FIG. 19, in one touch unit 5, adjacent two rows of the second electrode structures 602 are electrically connected and are electrically connected at the edge of the touch unit 5, and adjacent two column of the first electrode structures 601 are electrically connected. That is, metal lines in the dm1 to dm4 regions between adjacent two rows of the second electrode structures 602 in FIG. 17 are connected with metal lines of the second electrode structures 602. Metal lines between adjacent two columns of the first electrode structures 601 in FIG. 17 are electrically connected with the first electrode structures 601.

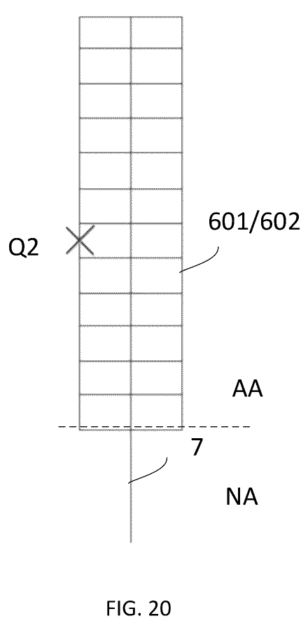

In this way, in the display region, paths of the first electrode structures are no longer independently arranged, and paths of the second electrode structures are no longer independently arranged. Even though, as shown in FIG. 20, a path of a first electrode structure 601 or a path of a second electrode structure 602 is locally damaged at Q2 due to process or reliability condition, neither the path of the first electrode structure 601 nor the path of the second electrode structure 602 is floating, so that yield and reliability of the touch display panel can be improved.

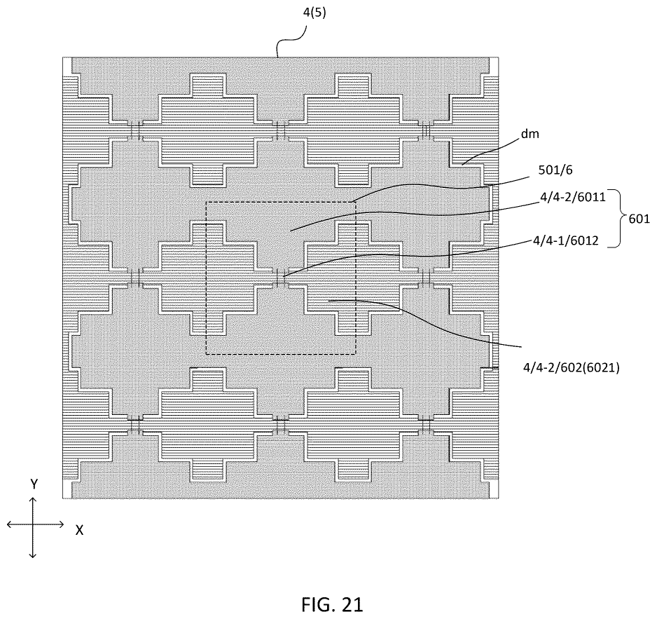

In some embodiments, as shown in FIG. 21, the dummy electrode dm is also located between the first sub-electrode 6011 and the second sub-electrode 6021.

It should be noted that, as shown in Table 2, when no dummy electrode is arranged between the first sub-electrode and the second sub-electrode, parasitic capacitance between the first sub-electrode and the second sub-electrode is 1.2 picofarads (pF). When a dummy electrode is arranged between the first sub-electrode and the second sub-electrode, the parasitic capacitance between the first sub-electrode and the second sub-electrode may be 0.8 pF. That is, in the touch display panel according to an embodiment of the present disclosure, the dummy electrode arranged between the first sub-electrodes 6011 and the second sub-electrodes 6021 can reduce the parasitic capacitance between the first sub-electrodes 6011 and the second sub-electrodes 6021.

TABLE 2

| | No dummy electrode is | A dummy electrode is |
|---|---|---|
| | arranged between the | arranged between the |
| | first sub-electrode and | first sub-electrode and |
| | the second sub-electrode | the second sub-electrode |
| Parasitic | 1.2 | 0.8 |
| capacitance (pF) | | |

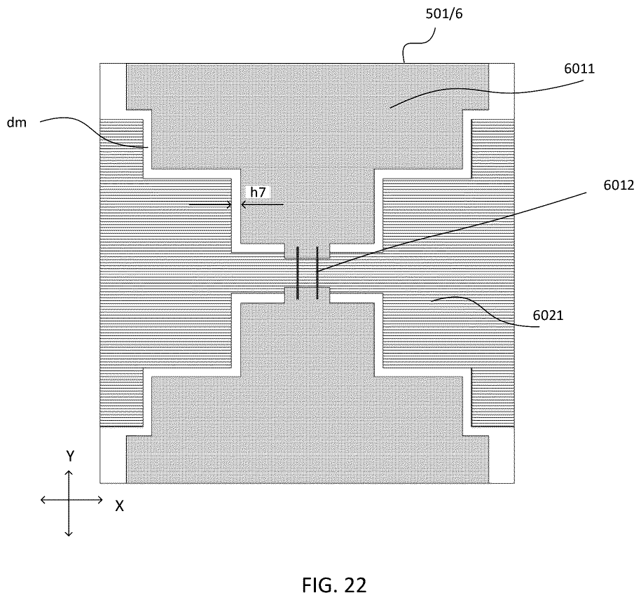

In some embodiments, as shown in FIG. 22, a distance h7 between the first sub-electrode 6011 and the second sub-electrode 6021 is greater than or equal to 40 micrometers and less than or equal to 80 micrometers, to further reduce the parasitic capacitance between he first sub-electrode 6011 and the second sub-electrode 6021, improving the touch signal amount, and further improving the touch accuracy.

A display apparatus according to an embodiment of the present disclosure includes the touch display panel according to embodiments of the present disclosure.

The display apparatus according to an embodiment of the present disclosure is any product or component with display function such as a mobile phone, a tablet computer, a television, a display, a notebook computer, a digital photo frame, a navigator. Other essential components of the display apparatus are as will be understood by those skilled in the art, and it is not intended to be exhaustive or to be limiting of the present disclosure. For implementations of the display apparatus, reference may be made to the above embodiments of the display panel, and the repetition thereof is omitted.

In summary, in the touch display panel and the display apparatus according to embodiments of the present disclosure,

$$0.7 \leq \frac{h 1}{D} \leq 1.8 , 0.7 \leq \frac{h 2}{D} \leq 1.8 .$$

That is, the difference between the size of the touch sub-unit and the tip diameter of the active stylus is small, sudden change of the signal amount when the active stylus passes through different regions can be avoided. The large deviation between the actually sensed touch position and the actual touch position is avoided, and the touch accuracy and linearity can be improved.

Although embodiments of the present disclosure have been described, those of skill in the art may otherwise make various modifications and variations to these embodiments once they are aware of the basic inventive concept. Therefore, the claims intend to include embodiments as well as all these modifications and variations falling within the scope of the present disclosure.

Apparently, those skilled in the art can make various modifications and variations to embodiments of the present disclosure without departing from the spirit and scope of embodiments of the present disclosure. In this way, if the modifications and variations of embodiments of the present disclosure fall within the scope of the claims of the present disclosure and their equivalent technologies, the present disclosure is also intended to include these modifications and variations.

1. A touch display panel, wherein the touch display panel performs touch control based on an active stylus, and the touch display panel comprises:
a display substrate; and
a plurality of touch conductive layers, located at a display side of the display substrate; wherein an orthographic projection of the plurality of touch conductive layers on the display substrate is divided into a plurality of touch units arranged in an array along a first direction and a second direction, one touch unit of the touch units comprises a plurality of touch sub-units arranged in n rows by n columns, wherein n is an integer greater than or equal to 2; the first direction intersects with the second direction, an extension direction of each row of the touch sub-units is the first direction, and an extension direction of each column of the touch sub-units is the second direction; a width h1 of one touch sub-unit of the touch sub-units in the first direction, a width h2 of the touch sub-unit in the second direction, and a tip diameter D of the active stylus satisfy:
$$0.7 \leq \frac{h 1}{D} \leq 1.8 , 0.7 \leq \frac{h 2}{D} \leq 1.8 .$$

2. The touch display panel according to claim 1, wherein 1 mm≤D≤1.2 mm; n=3, 1.2≤h1≤1.4, 1.2≤h2≤1.4.

3. The touch display panel according to claim 1, wherein 1 mm≤D≤1.2 mm; n=4, 0.9≤h1≤1.05, 0.9≤h2≤1.05.

4. The touch display panel according to claim 1, wherein 1.2 mm<D≤1.5 mm; n=3, 1.2≤h1≤1.4, 1.2≤h2≤1.4.

5. The touch display panel according to claim 1, wherein 1.2 mm<D≤1.5 mm; n=2, 1.9≤h1≤2.1, 1.9≤h2≤2.1.

6. The touch display panel according to claim 1, wherein one touch conductive layer of the touch conductive layers comprises a metal grid structure formed by interweaving a plurality of metal lines;
the plurality of touch conductive layers comprise a first touch conductive layer and a second touch conductive layer; an orthographic projection of the first touch conductive layer on the display substrate and an orthographic projection of the second touch conductive layer on the display substrate have an overlapping region;
a line width of a metal line of the first touch conductive layer in the overlapping region is less than a line width of a metal line of the first touch conductive layer in a remaining region;
a line width of a metal line of the second touch conductive layer in the overlapping region is less than a line width of a metal line of the second touch conductive layer in a remaining region.

7. The touch display panel according to claim 1, wherein the touch sub-unit comprises a first electrode structure and a second electrode structure intersecting with each other; the first electrode structure comprises two first sub-electrodes arranged along the second direction, and a bridging electrode electrically connecting the two first sub-electrodes; the second electrode structure comprises two second sub-electrodes arranged along the first direction;
the first sub-electrode and the second sub-electrode are located in the same touch conductive layer, and the bridging electrode is located in a different touch conductive layer from the first sub-electrode and the second sub-electrode;
an orthographic projection of the bridging electrode on the display substrate overlaps with an orthographic projection of the second sub-electrode on the display substrate.

8. The touch display panel according to claim 7, wherein the touch unit comprises n rows of second electrode structures and n columns of first electrode structures;
a plurality of rows of the second electrode structures in the same row of the touch units are electrically connected with each other, and a plurality of columns of the first electrode structures in the same column of the touch units are electrically connected with each other;
or, a plurality of rows of the second electrode structures in the same row of the touch units are used for accessing the same touch signal, and a plurality of columns of the first electrode structures in the same column of the touch units are used for accessing the same touch signal.

9. The touch display panel according to claim 7, wherein the touch conductive layer comprises metal lines;
the bridging electrode comprises m metal lines arranged along the first direction; wherein m is an integer greater than 2.

10. The touch display panel according to claim 7, wherein the touch conductive layer comprises metal lines;
the orthographic projection of the bridging electrode on the display substrate and the orthographic projection of the second sub-electrode on the display substrate have an overlapping region, and the second sub-electrode comprises k metal lines arranged along the second direction; wherein k is an integer greater than 2.

11. The touch display panel according to claim 7, wherein the touch conductive layer comprises metal lines with an extension direction intersecting with both the first direction and the second direction;
a shape enclosed by orthographic projections of metal lines of the bridging electrode on the display substrate is a rectangle.

12. The touch display panel according to claim 7, wherein a distance between the first sub-electrode and the second sub-electrode is greater than or equal to 40 micrometers and less than or equal to 80 micrometers.

13. The touch display panel according to claim 7, wherein an outline of the touch sub-unit is a rectangle;
each of an outline of the first sub-electrode close to the second sub-electrode and an outline of the second sub-electrode close to the first sub-electrode is a broken line.

14. The touch display panel according to claim 13, wherein each of the outline of the first sub-electrode close to the second sub-electrode and the outline of the second sub-electrode close to the first sub-electrode comprises a plurality of first line segments and second line segments alternately arranged, the first line segments extend along the first direction, and the second line segments extend along the second direction.

15. The touch display panel according to claim 13, wherein the first sub-electrode comprises a first rectangular region and a first region located at a side of the first rectangular region in the second direction;
the second sub-electrode comprises a second rectangular region and a second region located at a side of the second rectangular region in the first direction;
an outline of a pattern formed by two first regions located between two first rectangular regions in the second direction and two second regions located between two second rectangular regions in the first direction is a rectangle.

16. A display apparatus, comprising the touch display panel according to claim 1.
